(19) United States
(12) Patent Application Publication
(10) Pub. No.: US 2025/0170761 A1
(43) Pub. Date: May 29, 2025

(54) POST-CONSUMER RECYCLATED COLORED POLYPROPYLENE COMPOSITION

(71) Applicant: Borealis AG, Vienna (AT)

(72) Inventors: Tuan Anh Tran, Linz (AT); Andreas Nagl, Linz (AT); Doris Machl, Linz (AT); Peter Denifl, Linz (AT); Kilian Piettre, Linz (AT); Christian Goetzloff, Linz (AT); Michael Hettrich-Keller, Linz (AT); Sameer Vijay, Linz (AT); Hans-Jurgen Priesters, Schleiden-Wintzen (DE); Oliver Lambertz, Roesrath (DE)

(21) Appl. No.: 18/842,530

(22) PCT Filed: Mar. 20, 2023
(86) PCT No.: PCT/EP2023/057100

§ 371 Date: Aug. 29, 2024

(30) Foreign Application Priority Data
Mar. 22, 2022 (EP) 22163635.0
Sep. 23, 2022 (EP) 22197526.1

(51) Int. Cl. B29B 17/02; B29B 9/12; B29B 9/16; B29B 17/00; B29B 17/04; B29K 23/00; B29K 105/26

(52) U.S. Cl. CPC B29B 17/02; B29B 9/12; B29B 17/04; B29B 2009/166; B29B 2017/0015; B29B 2017/0203; B29B 2017/0224; B29B 2017/0234; B29K 2023/12; B29K 2105/26; B29K 2995/0041

(57) ABSTRACT

The present invention concerns a polypropylene mixed color blend having (i) a crystalline fraction (CF) content determined according to CRYSTEX QC analysis, in the range from 85.0 to 95.0 wt.-%, (ii) a soluble fraction (SF) content in the range from 5.0 to 15.0 wt.-%, (iii) a total ethylene content (C2), in the range from 2.0 to 10.0 wt.-%, (iv) said crystalline fraction (CF) has a propylene content (C3 (CF)) as determined by FT-IR spectroscopy calibrated by quantitative 13C-NMR spectroscopy, in the range from 93.0 to 99.0 wt.-%; (v) said crystalline fraction (CF) has an ethylene content (C2 (CF)), as determined by FT-IR spectroscopy calibrated by quantitative 13C-NMR spectroscopy, in the range from [C2]-3.4 wt.-% to [C2]-0.2 wt.-%, wherein [C2] is the total ethylene content (C2) defined in (iii), (vi) a CIELAB color space (L*a*b*) measured according to DIN EN ISO 11664-4, of L* from 30.0 to 73.0; a* from −10 to 25; and b* from −5 to 20. The invention also concerns a method for obtaining the above polypropylene mixed color blend and its use for household applications, automotive applications, appliances, packaging, or wire and cable applications. The invention further concerns articles made from the above polypropylene mixed color blend, e.g. for caps, closures, bottles, containers, automotive articles, and wire and cable articles.

The present invention relates to mixed-color polypropylene blends originating from post-consumer recyclates (PCR).

### BACKGROUND OF THE INVENTION

The challenge of disposal of accumulated plastic waste and corresponding environmental issues have received widespread attention from the public and industry. Therefore, recycling of plastic material has become an important topic, where plastic waste can be turned into valuable resources for new plastic products. Hence, environmental and economic aspects can be combined in recycling and reusing plastic material.

Although recycling of plastic material has already begun in the mid-90s by implementing collection systems, which allow more target orientated collection and separation of plastic materials from other household waste materials, the reuse of plastic material originating from plastic waste is still limited. The so-called post-consumer recycled (PCR) plastic material generally contains mixtures of different plastics and several contaminant materials. Methods have been developed to further purify the post-consumer recycled (PCR) plastic material.

Many attempts have been made for purifying recycling streams as originating from post-consumer plastic waste. Among those measures washing, sieving, aeration, distillation and the like may be mentioned. For example, WO2018/046578 A1 discloses a process for the production of polyolefin recyclates from mixed color polyolefin waste including packaging waste comprising cold washing the waste with water followed by washing with an alkali medium at 60° C., followed by flake color sorting to receive color sorted mono polyolefin rich fractions.

U.S. Pat. No. 5,767,230 A describes a process comprising contacting PCR polyolefin chips containing volatile impurities with a heated gas at a superficial velocity sufficient to substantially reduce the volatile impurities such as odor active substances. However, up to now contamination by residual amounts of benzene turned out to be a problem. The origin of residual amounts of benzene in post-consumer recyclates is still dubious but constitutes a hurdle for end-uses in fields such as medical packaging, food packaging and the like. Residual amounts, i.e. traces of benzene constitute a particularly problem as odor tests by sniffing experiments become impossible. Thus, end-uses having certain demands as to the odor are blocked.

WO 2020/182435 A1 discloses a polymer composition consisting of 50-90 wt % of a recycled polypropylene; 4-50 wt % of talcum; 0-10 wt % of additives; wherein the additives are selected from the group of polyethylenes (PEs), maleic anhydride grafted PEs (PE-MAs), maleic anhydride, grafted PPs (PP-MAs), stabilizers, peroxides, calcium oxides (CaOs) or colorants; wherein the talcum has a D50 of less than 4 micron (ISO13317-3) and wherein wt % is relative to the total weight of the polymer composition.

As yet a further problem known recyclates suffer from moderate homogeneity as reflected by surface contamination occurring in injection molded products.

Post-consumer polypropylene-based recyclates (PP-PCR) produced from mechanical recycling process are still challenging in meeting certain requirements, such as purity, contaminants, bright/white color, mal-odour, quality consistency, consistency between the batches, and homogeneity.

Thus, there is still a strong need for recycled materials with properties as close as possible to virgin resins. In particular, it is the object of the present invention to provide PP-PCR materials, which are superior to existing materials in high purity of the product in terms of polypropylene content, low content of contaminants, brighter shade of grey color, low emissions (e.g. total carbon emission, VOC, FOG), high color consistency, high homogeneity, high tensile strength, and good processability.

### SUMMARY OF THE INVENTION

The objective problem of the present invention is to provide a post-consumer recycled polypropylene composition that addresses the above-described needs and disadvantages.

Accordingly, the present invention provides a polypropylene mixed color blend having
(i) a crystalline fraction (CF) content determined according to CRYSTEX QC analysis, as determined herein, in the range from 85.0 to 95.0 wt.-%,
(ii) a soluble fraction (SF) content determined according to CRYSTEX QC analysis, as determined herein, in the range from 5.0 to 15.0 wt.-%,
(iii) a total ethylene content (C2), determined according to CRYSTEX QC analysis, as determined herein, in the range from 2.0 to 10.0 wt.-%,
(iv) said crystalline fraction (CF) has a propylene content (C3 (CF)) as determined by FT-IR spectroscopy calibrated by quantitative ¹³C-NMR spectroscopy, as determined herein, in the range from 93.0 to 99.0 wt.-%;
(v) said crystalline fraction (CF) has an ethylene content (C2 (CF)), as determined by FT-IR spectroscopy calibrated by quantitative ¹³C-NMR spectroscopy, as determined herein, in the range from [C2]-3.4 wt.-% to [C2]-0.2 wt.-%, wherein [C2] is the total ethylene content (C2) defined in (iii),
(vi) a CIELAB color space (L*a*b*) measured according to DIN EN ISO 11664-4, as described herein, of
   L* from 30.0 to 73.0;
   a* from −10 to 25;
   b* from −5 to 20.

The present invention further provides a method of recycling a polypropylene mixed color material, comprising the steps of:
a) providing a mixed plastic recycling stream (A);
b) sieving the mixed plastic recycling stream (A) to create a sieved mixed plastic recycling stream (B) having only articles with a longest dimension in the range from 30 to 400 mm;
c) sorting the sieved mixed plastic recycling stream (B) by means of one or more sorting systems including near infrared (NIR) and optical sensors wherein the sieved mixed plastic recycling stream (B) is at least sorted by color and polymer type, thereby generating a sorted mixed color polypropylene recycling stream (CM) that is subjected to steps d) and beyond;
d) shredding the sorted mixed color polypropylene recycling stream (CM) to form a flaked mixed color polypropylene recycling stream (D);
e) washing the flaked mixed color polypropylene recycling stream (D) with a first aqueous washing solution (W1) without the input of thermal energy, thereby generating a first suspended polypropylene recycling stream (E);
f) removing at least part of the first aqueous washing solution (W1) from the first suspended polypropylene recycling stream (E) to obtain a first washed polypropylene recycling stream (F);
g) washing the first washed polypropylene recycling stream (F) with a second aqueous washing solution (W2) thereby generating a second suspended polypropylene recycling stream (G), wherein sufficient thermal energy is introduced to the second suspended polypropylene recycling stream (G) to provide a temperature in the range from 65 to 95° C. during the washing;
h) removing the second aqueous washing solution (W2) and any material not floating on the surface of the second aqueous washing solution from the second suspended polypropylene recycling stream (G) to obtain a second washed polypropylene recycling stream (H); and
i) drying the second washed polypropylene recycling stream (H), thereby obtaining a dried polypropylene recycling stream (I), which contains the polypropylene mixed color blend according to the present invention.

The present invention further provides articles comprising the polypropylene mixed color blend of the invention, whereby said polypropylene mixed color blend preferably amounts to at least 85 wt. %, more preferably 90 wt.-%, even more preferably 93 wt.-% of the components for making the article. These articles are particularly useful for making caps, closures, bottles, containers, automotive articles, and wire and cable articles.

The polypropylene mixed color blend according to the present invention may preferably further comprise at least one virgin polypropylene and/or a further recycled polypropylene to form a blend, which is useful for making the above articles.

### DETAILED DESCRIPTION OF THE INVENTION

For the purposes of the present description and of the subsequent claims, the term “recycled waste” is used to indicate a material recovered from both post-consumer waste, as opposed to virgin polymers and/or materials. Post-consumer waste refers to objects having completed at least a first use cycle (or life cycle), i.e. having already served their first purpose. The term “virgin” denotes the newly produced materials and/or objects prior to their first use, which have not already been recycled. The term “recycled material” such as used herein denotes materials reprocessed from “recycled waste”.

A blend denotes a mixture of two or more components, wherein at least one of the components is polymeric. In general, the blend can be prepared by mixing the two or more components. Suitable mixing procedures are known in the art. If such a blend includes a virgin material, said virgin material preferably is a polypropylene comprising at least 90 wt.-% of a reactor made polypropylene material, as well as optionally carbon black. A virgin material is a polymeric material which has not already been recycled.

For the purposes of the present description and of the subsequent claims, the term “polypropylene mixed color blend” indicates a polymer material including predominantly units derived from propylene apart from other polymeric ingredients of arbitrary nature. Such polymeric ingredients may for example originate from monomer units derived from alpha olefins such as ethylene, butylene, octene, and the like, styrene derivatives such as vinylstyrene, substituted and unsubstituted acrylates, substituted and unsubstituted methacrylates.

Said polymeric materials can be identified in the polypropylene mixed color blend by means of quantitative ¹³C {1H} NMR measurements as described herein. In the quantitative ¹³C {1 H} NMR measurement used herein and described below in the measurement methods different units in the polymeric chain can be distinguished and quantified. These units are propylene units (C3 units), units having 2, 4 and 6 carbons and units having 7 carbon atoms. Thereby, the units having 2 carbon atoms (C2 units) can be distinguished in the NMR spectrum as isolated C2 units and as continuous C2 units which indicate that the polymeric material contains an ethylene based polymer. The polypropylene mixed color blend according to the present invention usually include low amounts of ethylene-based polymeric components.

Conventionally, further components such as fillers, including organic and inorganic fillers for example talc, chalk, carbon black, and further pigments such as TiO₂ as well as paper and cellulose may be present.

The present invention has found that the above objects can be achieved by the above-defined polypropylene mixed color blend.

The polypropylene mixed color blend according to the present invention preferably has a crystalline fraction (CF) content determined according to CRYSTEX QC analysis in the range from 85.0 to 93.0 wt.-%, more preferably from 88.0 to 93.0 wt.-%.

The crystalline fraction (CF) of the polypropylene mixed color blend according to the present invention preferably has a propylene content (C3 (CF)) as determined by FT-IR spectroscopy calibrated by quantitative ¹³C-NMR spectroscopy, in the range from 94.0 to 99.0 wt.-%, more preferably from 95.0 to 98.5 wt.-%.

The crystalline fraction (CF) of the polypropylene mixed color blend according to the present invention preferably has an ethylene content (C2 (CF)), as determined by FT-IR spectroscopy calibrated by quantitative ¹³C-NMR spectroscopy, as determined herein, in the range from [C2]-3.0 to [C2]-0.6 wt.-%, more preferably from [C2]-2.4 to [C2]-1.2 wt.-%, wherein [C2] is the total ethylene content (C2) determined according to CRYSTEX QC analysis.

The polypropylene mixed color blend preferably has a total ethylene content (C2), determined according to CRYSTEX QC analysis, in the range from 2.5 to 8.0 wt.-%, and more preferably from 3.0 to 6 wt.-%, based on the total weight of the polypropylene mixed color blend.

The polypropylene mixed color blend according to the present invention preferably has a CIELAB color space (L*a*b*) measured according to DIN EN ISO 11664-4, as described herein, of
L* from 40 to 65;
a* from −8 to 20;
b* from −3 to 15,
   wherein each of the above ranges for L*, a* and b* may be combined with each other independently.

The polypropylene mixed color blend according to the present invention preferably has a soluble fraction (SF) obtained by CRYSTEX QC analysis in the range of from 6.0 to 11.0 wt.-%, more preferably from 7.0 to 10.0 wt.-%.

The polypropylene mixed color blend according to the present invention preferably has an ethylene content in the soluble fraction (C2 (SF)), obtained by CRYSTEX QC analysis, as determined by FT-IR spectroscopy calibrated by quantitative ¹³C-NMR spectroscopy from 21.0 to 28.0 wt.-%, more preferably from 22.0 to 27.0 wt.-%.

The polypropylene mixed color blend according to the present invention preferably has inorganic residues as measured by calcination analysis (TGA) according to DIN ISO 1172:1996 of 0.1 to less than 2.0 wt.-%, more preferably from 0.3 to 1.5 wt.-%, with respect to the total weight of the polypropylene mixed color blend. The results of the calcination analysis (TGA) are also termed herein as ash content.

The polypropylene mixed color blend according to the present invention preferably has a total carbon emission, measured by HS GC-FID according to VDA277 of from 1.0 to 30 μg carbon/g, more preferably from 5.0 to 25 μg carbon/g, with respect to the weight of the polypropylene mixed color blend.

The polypropylene mixed color blend according to the present invention preferably has a total volatile organic content (VOC), measured by HS GC-FID according to VDA278 of from 10 to 150 μg/g, more preferably from 20 to 120 μg/g, even more preferably from 20 to 80 μg/g with respect to the weight of the polypropylene mixed color blend.

The polypropylene mixed color blend according to the present invention preferably has a total condensable organic content (FOG), measured by HS GC-FID according to VDA278 of from 20 to 450 μg/g, more preferably from 30 to 420 μg/g, with respect to the weight of the polypropylene mixed color blend.

The polypropylene mixed color blend according to the present invention preferably has an odor (VDA270-B3) of 5.0 or lower, more preferably 4.8 or lower. It should be understood that many commercial recycling grades which do not report odor are in fact even worse, as an odor test according to VDA270 is forbidden due to the presence of problematic substances.

The polypropylene mixed color blend according to present invention preferably has a Large Amplitude Oscillatory Shear-Non-Linear Factor (LAOS-NLF), determined at 190° C., an angular frequency of 0.628 rad/s and a strain of 1000%, in the range of 1.5 to 3.5, whereby

$$LAOS - NLF = \vert \frac{{G}_{1}^{′}}{{G}_{3}^{′}} \vert$$

whereby
G₁′ is the first order Fourier Coefficient
G₃′ is the third order Fourier Coefficent

Without wishing to being bound by theory, it is believed that the processing of the polymer contributes to branching triggered by enclosed contaminants. The LAOS-NLF may be influenced by selecting feedstock such that about 10 wt.-% of the material is soft polypropylene. It should be understood that several regions operate collection stations collecting highly consumer pre-sorted plastics. Such highly valuable plastics streams are commercially available and allow upgrading of other low quality streams (such as by a softer polypropylene mixture) from other waste disposal resources.

The polypropylene mixed color blend according to present invention preferably has a tensile modulus (ISO 527-2 at a cross head speed of 1 mm/min; 23° C.) using injection molded specimens as described in EN ISO 1873-2 (dog bone shape, 4 mm thickness) of at least 1200 MPa, more preferably at least 1250 MPa, even more preferably at least 1300 MPa. Such relatively high flexural modulus results from the relatively low amounts of rubber like and plastomer like materials in the blend.

The polypropylene mixed color blend according to present invention preferably has a tensile modulus in the range of from 1200 to 1500 MPa, more preferably in the range of from 1250 to 1480 MPa.

The polypropylene mixed color blend according to present invention preferably has a tensile strain at break, determined according to ISO 527-2 and as described in the experimental section below, in the range of 5 to 350%, more preferably in the range of 10 to 200%, even more preferably 15 to 150%.

The polypropylene mixed color blend according to present invention preferably has a Charpy impact strength, determined at 23° C. according to ISO 179-1/1eA and as described in the experimental section below, in the range of from 3.5 to 12.0 KJ/m², more preferably in the range of from 4.0 to 10.0 KJ/m², even more preferably 4.5 to 9 KJ/m².

The polypropylene mixed color blend according to present invention preferably has an intrinsic viscosity of the soluble fraction (IV (SF)), determined according to CRYSTEX QC analysis, as determined in the experimental section below, in the range of from 1.0 to 2.2 dl/g, more preferably in the range of from 1.2 to 2.1 dl/g, even more preferably in the range of from 1.3 to 2.0 dl/g.

The polypropylene mixed color blend according to present invention preferably has a shear thinning factor (STF) value, defined as the ratio of the complex viscosities at 0.05 rad/s, eta (0.05), to that of at 300 rad/s, eta (300), at 230° C., which are performed in a frequency range of 0.01 and 628 rad/s according to ISO 6721-1 and 6721-10, in the range of from 7.5 to 15, more preferably in the range of from 8.0 to 13. STF is a rheological measure indicating the molecular weight broadness of the polymer. The determination of STF is explained in the experimental section below. The higher the STF value, the broader is the molecular weight broadness of the material which favors the processability of the material.

The polypropylene mixed color blend according to the present invention preferably has a melt flow rate MFR_{2.16} at 230° C., determined according to ISO 1133 of at least 5 g/10 min, more preferably at least 10 g/10 min. The MFR_{2.16} is preferably not more than 50 g/10 min, more preferably not more than 30 g/10 min.

For certain applications the polypropylene mixed color blend may be obtained by visbreaking preferably using peroxides. In these cases the MFR_{2.16} is preferably at least 50 g/10 min, more preferably at least 100 g/10 min, even more preferably at least 150 g/10 min.

The visbreaking step may preferably be performed either with a peroxide or mixture of peroxides or with a hydroxylamine ester or a mercaptane compound as source of free radicals (visbreaking agent) or by purely thermal degradation. The decomposition products of the visbreaking process can be found in the resulting blend. It should be understood that decomposition products of visbreaking process (as commonly used in the art for virigin materials) are not considered as impurities.

The process of visbreaking is known in the art and may be conducted as described e.g. in WO 2021/260053 A1.

The polypropylene mixed color blend according to present invention preferably has a density of from 900 to 940 kg/m³, more preferably from 905 to 935 kg/m³, even more preferably from 910 to 930 kg/m³.

The polypropylene mixed color blend according to the present invention is preferably obtained from post-consumer recyclates (PCR), preferably 100% PCR materials. Such PCR materials are typically obtained from consumer waste streams, such as waste streams originating from conventional collecting systems such as those implemented in the European Union (e.g. extended producer responsibility schemes, EPR schemes). PCR materials may also be derived from municipal solid waste originating outside of EPR collection systems.

The feedstock materials for obtaining the polypropylene mixed color blend according to the present invention may be selected from a wide range of fractions generated from municipal solid waste (MSS, also often referred to as residual waste, black bin waste) to Extended Producer Responsibility (EPR)-based feedstocks, for example the ARA 414 fraction from Altstoff Recycling Austria or the DSD 324 fraction from German Producer Responsibility Organisations, such as DSD-Duales System Holding, Interzero, Reclay.

It is preferred that the polypropylene mixed color blend according to the present invention comprises at least 95.0 wt.-%, more preferably at least 96 wt.-%, even more preferably at least 97 wt.-% originating from post-consumer waste.

The above objects can also be achieved by the above-described method of recycling a polypropylene mixed color material, comprising the steps a) to i). In other words, the polypropylene mixed color blend according to the present invention is preferably obtainable or is obtained by the above-described method or the preferred methods described below.

According to step c), the sieved mixed plastic recycling stream (B) may preferably be further sorted by article form. In this case artificial intelligence sorting systems (which are commercially available e.g. from Tomra Systems) may be used to sort also according to application type (MFR) or specific objects. In sorting step c) preferably white and natural waste materials are sorted out so that substantially only waste materials of non-white and/or non-natural colors remain in the one or more sorted mixed color polypropylene recycling stream(s) (CM).

By sorting step c) preferably one or more sorted mixed color polypropylene recycling stream(s) (CM) is generated. This can preferably be achieved by removing white and natural polypropylene objects and non-polypropylene objects. In this context “natural” signifies that the objects are of natural color. This means that essentially no pigments (including carbon black) or colorants such as dyes or inks are included in the objects. On the other hand, “white” signifies that white pigments are included in the objects. The same logic applies to the sorting of flakes as described in step k) below.

In step f), preferably substantially all of the first aqueous washing solution (W1) is removed from the first suspended polypropylene polyolefin recycling stream (E) to obtain said first washed polypropylene polyolefin recycling stream (F).

In step h) the removal of the second aqueous washing solution (W2) and any material not floating on the surface of the second aqueous washing solution is preferably achieved by a density separation step.

The method of the present invention may further comprise at least one of the following steps:
j) separating the dried polypropylene recycling stream (I) obtained from step i) into a light fraction and a heavy fraction polypropylene recycling stream (J);
k) further sorting the heavy fraction polypropylene recycling stream (J) or, in the case that step j) is absent, the dried polypropylene recycling stream (I) by means of one or more optical sorters with NIR and/or optical sensors sorting for one or more target polypropylene by removing any flakes containing material other than the one or more target polypropylene(s) or of flakes of undesired color (e.g white, black etc.), yielding a purified polypropylene recycling stream (K);
I) melt extruding, preferably pelletizing, the purified polypropylene recycling stream (K), preferably wherein additives (Ad) are added in the melt state, to form an extruded, preferably pelletized, recycled polypropylene product (L);
m) aerating the recycled polypropylene product (L) or, in the case that step I) is absent, the purified polypropylene recycling stream (K) to remove volatile organic compounds, thereby generating an aerated recycled polypropylene product (M), being either an aerated extruded, preferably pelletized, recycled polypropylene product (M1) or aerated recycled polypropylene flakes (M2),
   wherein the order of steps I) and m) can be interchanged, such that the purified polypropylene recycling stream (K) is first aerated to form aerated recycled polypropylene flakes (M2) that are subsequently extruded, preferably wherein additives (Ad) are added in the melt state, to form an extruded, preferably pelletized, aerated recycled polypropylene product (M3), which is the polypropylene mixed color blend according to the present invention.

In step j) the separation may preferably done by a windsifter. The separation may alternatively be done based on the aerodynamic properties of the particles (such as flakes, e.g. separating thin light flexible flakes from heavy thick rigid flakes.

After the above step j) a screening step j1) may be conducted, wherein the dried polypropylene recycling stream (I) is sieved to remove the fines, generating a sieved polypropylene recycling stream (J1), which may subsequently be subjected to optional step k) described above. In this screening step j1) fines of dimensions, preferably having a size of 2.5 mm or below are removed.

Further, the present invention is directed to articles made from the polypropylene mixed color blend according to the present invention, whereby said polypropylene mixed color blend preferably amounts to at least 85 wt. %, more preferably at least 90 wt.-%, even more preferably at least 93 wt.-% of the components for making the article. The above residual components may include additives such as antioxidants, stabilizers, carbon black, optionally in the form of a masterbatch, pigments, colorants such as dyes or inks.

According to the present invention, the articles may be selected from the group consisting of caps, closures, bottles, containers, automotive articles, and wire and cable articles.

The present invention is further directed to blends containing the polypropylene mixed color blend according to the present invention and at least one virgin polypropylene and/or a further recycled polypropylene. The virgin polypropylene may be selected from heterophasic polypropylenes, random propylene copolymers, and propylene homopolymers. The further recycled polypropylene may be the same or different from the polypropylene mixed color blend according to the present invention. It may also be derived from commercial sources, such as mentioned above.

The present invention is further directed to the use of the polypropylene mixed color blend according to according to the present invention for household applications, automotive applications, appliances, packaging, or wire and cable applications.

### Measurement Methods

The following definitions of terms and determination methods apply to the above general description of the invention as well as to the below examples, unless otherwise defined.

### a) Melt Flow Rate

The melt flow rate (MFR) was determined according to ISO 1133 and is indicated in g/10 min. The MFR is an indication of the flowability and hence the processability of the polymer. The higher the melt flow rate, the lower the viscosity of the polymer. Here, the MFR₂ was determined at a temperature of 230° C. and under a load of 2.16 kg.

### b) Isotacticity and Comonomer Content of Polypropylene

### Quantification of Microstructure by NMR Spectroscopy (Calibration Only)

Quantitative nuclear-magnetic resonance (NMR) spectroscopy was used for calibration.

Quantitative ¹³C {1H} NMR spectra were recorded in the solution-state using a Bruker Avance Neo 400 NMR spectrometer operating at 400.15 and 100.62 MHz for 1H and ¹³C respectively. All spectra were recorded using a ¹³C optimized 10 mm extended temperature probe head at 125° C. using nitrogen gas for all pneumatics. Approximately 200 mg of material was dissolved in approximately 3 ml of 1,2-tetrachloroethane-d2 (TCE-d2) along with approximately 3 mg BHT (2,6-di-tert-butyl-4-methylphenol CAS 128-37-0) and chromium-(III)-acetylacetonate (Cr(acac) 3) resulting in a 60 mM solution of relaxation agent in solvent as described in G. Singh, A. Kothari, V. Gupta, Polymer Testing 2009, 28 (5), 475.

To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimised tip angle, 1 s recycle delay and a bi-level WALTZ16 decoupling scheme as described in Z. Zhou, R. Kuemmerle, X. Qiu, D. Redwine, R. Cong, A. Taha, D. Baugh, B. Winniford, J. Mag. Reson. 187 (2007) 225 and V. Busico, P. Carbonniere, R. Cipullo, C. Pellecchia, J. Severn, G. Talarico, Macromol. Rapid Commun. 2007, 28, 1128. A total of 6144 (6k) transients were acquired per spectra. Quantitative ¹³C {1H} NMR spectra were processed, integrated and relevant quantitative properties determined from the integrals. All chemical shifts were indirectly referenced to the central methylene group of the ethylene block (EEE) at 30.00 ppm using the chemical shift of the solvent. This approach allowed comparable referencing even when this structural unit was not present.

Characteristic signals corresponding to the incorporation of ethylene were observed (as described in Cheng, H. N., Macromolecules 1984, 17, 1950) and the comonomer fraction calculated as the fraction of ethylene in the polymer with respect to all monomer in the polymer:

$$fE = ( E / ( P + E )$$

The comonomer fraction was quantified using the method of W-J. Wang and S. Zhu, Macromolecules 2000, 33 1157, through integration of multiple signals across the whole spectral region in the ¹³C {1H} spectra. Integral regions were slightly adjusted to increase applicability across the whole range of encountered comonomer contents.

The mole percent comonomer incorporation was calculated from the mole fraction:

$$E [ mol \% ] = 100 * fE$$

The weight percent comonomer incorporation was calculated from the mole fraction:

$$E [ wt \% ] = 100 * ( fE * 28.06 ) / ( ( fE * 28.06 ) + ( ( 1 - fE ) * 42. 08 ) ) .$$

### c) Crystex Analysis, Crystalline Fraction (CF) and Soluble Fraction (SF)

The crystalline (CF) and soluble fractions (SF) of the PCR polypropylene composition as well as the ethylene content and intrinsic viscosities of the respective fractions were analyzed by use of the CRYSTEX instrument, Polymer Char (Valencia, Spain) in line with ISO 6427 Annex B. Details of the technique and the method can be found in literature (Ljiljana Jeremic, Andreas Albrecht, Martina Sandholzer & Markus Gahleitner (2020) Rapid characterization of high-impact ethylene-propylene copolymer composition by crystallization extraction separation: comparability to standard separation methods, International Journal of Polymer Analysis and Characterization, 25:8, 581-596).

The crystalline and amorphous fractions are separated through temperature cycles of dissolution at 160° C., crystallization at 40° C. and re-dissolution in 1,2,4-trichlorobenzene at 160° C. Quantification of SF and CF and determination of ethylene content (C2) are achieved by means of an integrated infrared detector (IR4) and for the determination of the intrinsic viscosity (IV) an online 2-capillary viscometer is used.

The IR4 detector is a multiple wavelength detector measuring IR absorbance at two different bands (CH₃ stretching vibration (centered at app. 2960 cm-1) and the CH stretching vibration (2700-3000 cm-1) that are serving for the determination of the concentration and the ethylene content in ethylene-propylene copolymers. The IR4 detector is calibrated with series of 8 EP copolymers with known ethylene content in the range of 2 wt.-% to 69 wt.-% (determined by ¹³C-NMR) and each at various concentrations, in the range of 2 and 13 mg/ml. To encounter for both features, concentration and ethylene content at the same time for various polymer concentrations expected during Crystex analyses the following calibration equations were applied:

$$Conc = a + b ⋆ Abs ( CH ) + c * {( Abs ( CH ) )}^{2} + d ⋆ Abs ( {CH}_{3} ) + e * ( {Abs ( {CH}_{3} )}^{2} + f * Abs ( CH ) * Abs ( CH 3 )$$

$${CH}_{3} / 1000 C = a + b ⋆ Abs ( CH ) + c * Abs ( {CH}_{3} ) + d ⋆ ( Abs ( {CH}_{3} ) / Abs ( CH ) ) + e ⋆ {( Abs ( {CH}_{3} ) / Abs ( CH ) )}^{2}$$

The constants a to e for equation 1 and a to f for equation 2 were determined by using least square regression analysis.

The CH₃/1000C is converted to the ethylene content in wt.-% using following relationship:

$$Wt . - \% ( ethylene in EP copolymers ) = 100 - {CH}_{3} / 1000 TC * 0.3$$

Intrinsic viscosity (IV) of the PCR polypropylene composition and its soluble and crystalline fractions are determined with a use of an online 2-capillary viscometer and are correlated to corresponding IV's determined by standard method in decalin according to ISO 1628-3. Calibration is achieved with various EP PP copolymers with IV=2-4 dL/g. The determined calibration curve is linear:

$$IV ( dL / g ) = a * Vsp / c$$

The samples to be analyzed are weighed out in concentrations of 10 mg/ml to 20 mg/ml. To avoid injecting possible gels and/or polymers which do not dissolve in TCB at 160° C., like PET and PA, the weighed out sample was packed into a stainless steel mesh MW 0,077/D 0.05 mm.

After automated filling of the vial with 1,2,4-TCB containing 250 mg/l 2,6-tert-butyl-4-methylphenol (BHT) as antioxidant, the sample is dissolved at 160° C. until complete dissolution is achieved, usually for 60 min, with constant stirring of 400 rpm. To avoid sample degradation, the polymer solution is blanketed with the N2 atmosphere during dissolution.

A defined volume of the sample solution is injected into the column filled with inert support where the crystallization of the sample and separation of the soluble fraction from the crystalline part is taking place. This process is repeated two times. During the first injection the whole sample is measured at high temperature, determining the IV [dl/g] and the C2 [wt.-%] of the PP composition. During the second injection the soluble fraction (at low temperature) and the crystalline fraction (at high temperature) with the crystallization cycle are measured (wt.-% SF, wt.-% CF, wt.-% C2, IV), where the wt.-% CF is calculated in the following way:

$$wt . - \% CF = 100 - wt . - \% SF$$

### d) Cross Fractionation Chromatography

The chemical composition distribution as well as the determination of the molecular weight distribution and the corresponded molecular weight averages (Mn, Mw and Mv) at a certain elution temperature (polymer crystallinity in solution) were determined by a full automated Cross Fractionation Chromatography (CFC) as described by Ortin A., Monrabal B., Sancho-Tello J., Macromol. Symp., 2007, 257, 13-28.

A CFC instrument (PolymerChar, Valencia, Spain) was used to perform the cross-fractionation chromatography (TREF x SEC). A four band IR5 infrared detector (PolymerChar, Valencia, Spain) was used to monitor the concentration. The polymer was dissolved at 160° C. for 150 minutes at a concentration of around 1 mg/ml.

To avoid injecting possible gels and polymers, which do not dissolve in TCB at 160° C., like PET and PA, the weighed out sample was packed into stainless steel mesh MW 0,077/D 0,05 mmm.

Once the sample was completely dissolved an aliquot of 0.5 ml was loaded into the TREF column and stabilized for a while at 110° C. The polymer was crystallized and precipitate to a temperature of 30° C. by applying a constant cooling rate of 0.1° C./min. A discontinuous elution process is performed using the following temperature steps: (35, 40, 50, 55, 60, 65, 70, 75, 80, 85, 90, 95, 100, 103, 106, 109, 112, 115, 117, 119, 121, 123, 125, 127, 130, 135 and 140).

In the second dimension, the GPC analysis, 3 PL Olexis columns and 1x Olexis Guard columns from Agilent (Church Stretton, UK) were used as stationary phase. As eluent 1,2,4-trichlorobenzene (TCB, stabilized with 250 mg/L 2,6-Di tert butyl-4-methylphenol) at 150° C. and a constant flow rate of 1 mL/min were applied. The column set was calibrated using universal calibration (according to ISO 16014-2:2003) with at least 15 narrow MWD polystyrene (PS) standards in the range of 0.5 kg/mol to 11 500 kg/mol. Following Mark Houwink constants were used to convert PS molecular weights into the PP molecular weight equivalents.

$${K}_{PS} = 19 \times {10}^{- 3} mL / g , \qquad {α}_{PS} = 0.655$$

$${K}_{PP} = 19 \times {10}^{- 3} mL / g , \qquad {α}_{PP} = 0.725$$

A third order polynomial fit was used to fit the calibration data. Data processing was performed using the software provided from PolymerChar with the CFC instrument.

### e) Tensile Modulus and Tensile Strain at Break

Tensile modulus and tensile strain at break were measured according to ISO 527-2 (cross head speed=1 mm/min; test speed 50 mm/min at 23° C.) using injection molded specimens as described in EN ISO 1873-2 (dog bone shape, 4 mm thickness). The measurement is done after 96 h conditioning time of the specimen.

### f) Impact Strength (Charpy NIS)

Impact strength was determined as notched Charpy impact strength (1eA) (non-instrumented, ISO 179-1 at +23° C.) according to ISO 179-1 eA at +23° C. on injection moulded specimens of 80×10×4 mm prepared according to EN ISO 1873-2.

### g) Inorganic Residues

Inorganic residues were measured by TGA according to DIN ISO 1172:1996 using a Perkin Elmer TGA 8000. Approximately 10-20 mg of material was placed in a platinum pan. The temperature was equilibrated at 50° C. for 10 minutes, and afterwards raised to 950° C. under nitrogen at a heating rate of 20° C./min. The ash content was evaluated as the weight % at 850° C.

### h) CIELAB Color Space (L*a*b*)

In the CIE L*a*b* uniform color space, the color coordinates are: L*—the lightness coordinate; a*—the red/green coordinate, with +a* indicating red, and −a* indicating green; and b*—the yellow/blue coordinate, with +b* indicating yellow, and −b* indicating blue. The L*, a*, and b*coordinate axis define the three dimensional CIE color space. Standard Konica/Minolta Colorimeter CM-3700A.

### i) Odor (VDA270-B3)

VDA 270 is a determination of the odor characteristics of trim materials in motor vehicles. In this study, the odor is determined following VDA 270 (2018) variant B3 . . . . The odor of the respective sample is evaluated by each assessor according to the VDA 270 scale after lifting the jar's lid as little as possible. The hexamerous scale consists of the following grades: Grade 1: not perceptible, Grade 2: perceptible, not disturbing, Grade 3: clearly perceptible, but not disturbing, Grade 4: disturbing, Grade 5: strongly disturbing, Grade 6: not acceptable. Assessors stay calm during the assessment and are not allowed to bias each other by discussing individual results during the test. They are not allowed to adjust their assessment after testing another sample, either. For statistical reasons (and as accepted by the VDA 270) assessors are forced to use whole steps in their evaluation. Consequently, the odor grade is based on the average mean of all individual assessments, and rounded to whole numbers.

j) Total Organic Emissions from Non-Metallic Materials (VDA 277, January 1995)

The method description below provides an overview of relevant parameters to the skilled reader. In case of doubts, only the original method is valid for comparison of results. Equivalent standards to the VDA 277 are PV3341 (Volkswagen) and VCS 1027,2749 (Volvo).

The VDA 277 is intended for the determination of organic compounds emitting from non-metallic materials, which are relevant for the car interior. It allows the determination of the emission potential using the static headspace technique combined with gas chromatography.

For transportation and storage the sample requires sealed packaging in an aluminium coated polyethylene bag. If not described elsewhere the sample is neither openly stored nor by other means preconditioned prior to the analysis. Before the sample can be weighed in, injection moulded parts are cut into smaller pieces without risking the sample to heat up. Pellets are directly weighed in without an additional cutting step.

2 g of the respective sample are then placed in a 20 ml headspace vial and tightly closed. The vial is heated up immediately before the subsequent GC analysis. It is incubated for 5 hours (+/−5 min) at 120° C. (+/−1° C.) in a headspace sampler, which is connected to the gas chromatograph using a heated transfer line. The chromatographic separation is performed on a so called wax-type column (WCOT capillary column, 100% polyethylene glycol) for separation and a flame ionisation detector (FID) for detection.

For the evaluation only peaks
whose height exceeds the noise of the base line by at least 3 times, and
whose area is greater than 10% of the peak for the acetone area, where the concentration in the calibration solution was 0.5 g/l
   are considered.

The result is based on semi-quantitative evaluation where the total peak area of a sample chromatogram is subtracted by the peak area of the blank. The evaluation refers to a calibration with acetone and its carbon content, respectively. Thus, the resulting total emission value (or TVOC=total volatile organic compounds) is given in carbon equivalents.

### k) Thermal Desorption Analysis of Organic Emissions for the Characterization of Non-Metallic Materials (VDA 278, October 2011)

The method description below provides an overview of relevant parameters to the skilled reader. In case of doubts, only the original method is valid for comparison of results.

The VDA 278 is intended for the determination of emissions from non-metallic materials used for moulded parts in motor vehicles such as: textiles, carpets, adhesives, sealing compounds, foams, leather, plastic parts, films and sheets, paints or material combinations.

In a VDA 278 experiment, volatile and semi-volatile substances are extracted in a thermal desorption step from a sample by heat and a flow of inert gas (typically helium). The extracted compounds are cryo-focused in a cooling trap prior to the hot injection into a gas chromatograph for separation. Mass spectrometry is applied for detection.

The analysis comprises the semi-quantitation of two specifically defined cumulative emission values, namely the volatile organic compounds (VOC) and the portion of condensable substances (FOG value). In addition, individual substances are determined.

In the VOC analysis the sample is heated to 90° C. for 30 minutes to extract volatile organic compounds considering emissions up to n-pentacosane (C25) in the chromatogram. The FOG analysis involves a further thermal desorption step. For this purpose the sample is retained in the desorption tube after the VOC analysis and reheated to 120° C. for 60 minutes. The FOG value is defined as the fraction of semi-volatile organic compounds which elute in the chromatogram from n-tetradecane (C14) to n-dotriacontane (C32). The semi-quantitative analysis of the VOC value is calculated as the toluene equivalent. The FOG value is calculated as the hexadecane equivalent, respectively.

The apparatus used for the analysis must comply with the minimum requirements laid down in VDA 278 (chapter 3.1).

Although typical result variations of up to 15% within one single lab can be expected, no generally valid precision can be stated. Therefore, individual measurement series are required to investigate the relevant matrix.

According to the VDA 278 the obtained results are not suitable
for making further estimations of any kind of the health effects of the emitted substances,
to be used in any form as a basis for the estimation of concentrations which might be found in the interior of a complete vehicle in stationary condition, while driving or in conditions similar to driving.

### I) Dynamic Rheological Measurements

The characterisation of polymer melts by dynamic shear measurements complies with ISO standards 6721-1 and 6721-10. The measurements were performed on an Anton Paar MCR501 stress controlled rotational rheometer, equipped with a 25 mm parallel plate geometry. Measurements were undertaken on compression moulded plates, using nitrogen atmosphere and setting a strain within the linear viscoelastic regime. The oscillatory shear tests were done at 190° C. and 200° C. for PE and PP respectively applying a frequency range between 0.01 and 600 rad/s and setting a gap of 1.3 mm.

In a dynamic shear experiment the probe is subjected to a homogeneous deformation at a sinusoidal varying shear strain or shear stress (strain and stress controlled mode, respectively). On a controlled strain experiment, the probe is subjected to a sinusoidal strain that can be expressed by

$$( t ) = {γ}_{0} sin ( ω t ) \qquad ( 1 )$$

If the applied strain is within the linear viscoelastic regime, the resulting sinusoidal stress response can be given by

$$( t ) = {σ}_{0} sin ( ω t + δ ) \qquad ( 2 )$$

where
σ₀ and γ₀ are the stress and strain amplitudes, respectively
ω is the angular frequency
δ is the phase shift (loss angle between applied strain and stress response)
t is the time.

Dynamic test results are typically expressed by means of several different rheological functions, namely the shear storage modulus G′, the shear loss modulus, G″, the complex shear modulus, G*, the complex shear viscosity, η*, the dynamic shear viscosity, η′, the out-of-phase component of the complex shear viscosity η″ and the loss tangent, tan δ which can be expressed as follows:

$${G}^{′} = \frac{{σ}_{0}}{{γ}_{0}} cos δ [ Pa ] \qquad ( 3 )$$

$${G}^{′} = \frac{{σ}_{0}}{{γ}_{0}} sin δ [ Pa ] \qquad ( 4 )$$

$${G}^{*} = {G}^{′} + i {G}^{′′} [ Pa ] \qquad ( 5 )$$

$${η}^{*} = {η}^{′} - i {η}^{′′} [ Pa \cdot s ] \qquad ( 6 )$$

$${η}^{′} = \frac{{G}^{′′}}{ω} [ Pa \cdot s ] \qquad ( 7 )$$

$${η}^{′′} = \frac{{G}^{′}}{ω} [ Pa \cdot s ] \qquad ( 8 )$$

The determination of so-called Shear Thinning Factor (STF) is done, as described in equation 9.

$$STF = \frac{Eta * for ( ω = 0.05 rad / s )}{Eta * for ( ω = 300 rad / s )} [ ] \qquad ( 9 )$$

The values are determined by means of a single point interpolation procedure, as defined by Rheoplus software. In situations for which a given G* value is not experimentally reached, the value is 10 determined by means of an extrapolation, using the same procedure as before. In both cases (interpolation or extrapolation), the option from Rheoplus “-Interpolate y-values to x-values from parameter” and the “logarithmic interpolation type” were applied.

These tests were done on compression molded discs done with cryomilled powder.

### m) LAOS Non-Linear Viscoelastic Ratio

The investigation of the non-linear viscoelastic behavior under shear flow was done resorting to Large Amplitude Oscillatory Shear. The method requires the application of a sinusoidal strain amplitude, y0, imposed at a given angular frequency, w, for a given time, t. Provided that the applied sinusoidal strain is high enough, a non-linear response is generated. The stress, σ is in this case a 20 function of the applied strain amplitude, time and the angular frequency. Under these conditions, the non-linear stress response is still a periodic function; however, it can no longer be expressed by a single harmonic sinusoid. The stress resulting from a non-linear viscoelastic response [0-0] can be expressed by a Fourier series, which includes the higher harmonics contributions:

$$σ ( t , ω , {γ}_{0} ) = {γ}_{0} \cdot {\sum }_{n} [ {G}_{n}^{′} ( ω , {γ}_{0} ) \cdot sin ( n ω t ) + {G}_{n}^{′′} ( ω , {γ}_{0} ) \cdot cos ( n ω t ) ]$$

with, σ—stress response
t—time
ω—frequency
γ0—strain amplitude
η—harmonic number
G′ₙ—n order elastic Fourier coefficient
G″ₙ—n order viscous Fourier coefficient

The non-linear viscoelastic response was analysed applying Large Amplitude Oscillatory Shear (LAOS) [4-6]. Time sweep measurements were undertaken on an RPA 2000 rheometer from Alpha Technologies coupled with a standard biconical die. During the course of the measurement the test chamber is sealed and a pressure of about 6 MPa is applied. The LAOS test is done applying a 10 temperature of 190° C., an angular frequency of 0.628 rad/s and a strain of 1000%. In order to ensure that steady state conditions are reached, the non-linear response is only determined after at least 20 cycles per measurement are completed. The Large Amplitude Oscillatory Shear Non-Linear Factor (LAOS_NLF) is defined by:

$${LAOS}_{NLF} ( 1000 \% ) = \vert \frac{{G}_{1}^{′}}{{G}_{3}^{′}} \vert$$

where G′₁—first order Fourier Coefficient
G′₃—third order Fourier Coefficient

These tests were done on cryomilled powder.
[1] J. M. Dealy, K. F. Wissbrun, Melt Rheology and Its Role in Plastics Processing: Theory and Applications; edited by Van Nostrand Reinhold, New York (1990)
[2] S. Filipe, Non-Linear Rheology of Polymer Melts, AIP Conference Proceedings 1152, pp. 168-174 (2009)
[3] M. Wilhelm, Macromol. Mat. Eng. 287, 83-105 (2002)
[4] S. Filipe, K. Hofstadler, K. Klimke, A. T. Tran, Non-Linear Rheological Parameters for Characterisation of Molecular Structural Properties in Polyolefins, Proceedings of Annual European Rheology Conference, 135 (2010)
[5] S. Filipe, K. Klimke, A. T. Tran, J. Reussner, Proceedings of Novel Non-Linear Rheological Parameters for Molecular Structural Characterisation of Polyolefins, Novel Trends in Rheology IV, Zlin, Check Republik (2011)
[6] K. Klimke, S. Filipe, A. T. Tran, Non-linear rheological parameters for characterization of molecular structural properties in polyolefins, Proceedings of European Polymer Conference, Granada, Spain (2011)

### EXAMPLES

The feedstock material for IE1 was obtained from DSD 324 (German Green Dot System), based on EPR-based feedstock.

The feedstock material for IE2 was obtained from polypropylene sorted from Municipal Solid Waste from Poland and Greece.

The feedstock material for CE1 was obtained from Purpolen® PP-70. Purpolen® PP-70 is a grey post consumer recyclate mainly comprising pre-sorted community garbage, which is a commercial product produced by mtm plastics GmbH, Niedergebra, Germany.

The feedstock material for CE2 was obtained from Van Werven BB2 06/2020, a rigid plastic waste material from post-consumer recyclates in flakes form, which are already sorted and washed. The flakes are submitted to pelletization to produce pellets.

For obtaining the materials of IE1 and IE2, from these feedstock materials a polypropylene mixed color blend was obtained by:
sorting out non-polypropylene materials including polystyrene, polyamide, polyethylene, metals, paper and wood thereby providing a post-consumer plastic material;
sorting out natural (i.e. uncolored) and white products and thereby providing a post-consumer mixed color polypropylene recycling stream with defined color mix, resulting in a grey/greyish final color after extrusion, e.g. shampoo or shower gel bottles, cans, and the like;
subjecting the selected post-consumer plastic material with this defined color mix to milling, washing in an aqueous solution with various detergents and subsequent drying, windsifting and screening;
subjecting the pretreated post-consumer plastic material to a further sorting for eliminating non-polyolefin and colored parts yielding a purified polypropylene polyolefin recycling stream;
melt-extruding the material and yielding the polypropylene blend in the form of pellets as an extruded, pelletized, recycled polypropylene product; and
aerating the extruded, pelletized, recycled polypropylene product which is carried out at a temperature in a range of 100-130° C. by preheating the extruded, pelletized, recycled polypropylene product to the target temperature using an air stream having a temperature of at least 100° C.

The properties of the obtained polypropylene mixed color blends and the commercial samples are shown in the Table below.

TABLE

| | IE1 | IE2 | CE1 | CE2 |
|---|---|---|---|---|
| Odor VDA270-B3 | 4.0 | 4.7 | not | 4.7 |
| | | | possible | |
| | | | due to | |
| | | | hazardous | |
| | | | substances | |
| HS GC-FID (VDA277) - | 14 | 19 | 58 | 42 |
| Total Carbon | | | | |
| Emission, μgC/g | | | | |
| TD GC-FID (VDA278) - | 40 | 44 | 70 | 149 |
| VOC (<C25), μg/g | | | | |
| TD GC-FID (VDA278) - | 403 | 373 | 450 | 587 |
| FOG (C14-C32), | | | | |
| μg/g | | | | |
| Density | 915.1 ± | 918.3 ± | 919 ⁽¹⁾ | 927 |
| (kg/m³) | 0.1 | 0.1 | | |
| MFR(230° C./2.16 kg) | 14 | 17 | 20.8 ⁽¹⁾ | 24.9 |
| Polyamide - PA (IR), | not | not | 0.1 | not |
| wt % | detectable | detectable | | detectable |
| Polystyrene - PS | not | not | 0.4 | not |
| (IR), wt % | detectable | detectable | | detectable |
| Talc wt % (IR) | 0.3 | 0.2 | | 0.8 |
| Chalk wt % (IR) | 0.1 | 0.4 | | 1.0 |
| Carbon Black (TGA), | 0.01 | 0.01 | | |
| wt % | | | | |
| Calculated TiO₂ | 0.45 | 0.62 | | 0.47 |
| (XRF), % | | | | |
| Ash content (TGA), | 0.96 | 1.27 | 1.6 ⁽³⁾ | 2.4 |
| wt % | | | | |
| SF - Soluble fraction | 9.5 | 9.8 | 11.5 | 13.6 |
| (Crystex), wt % | | | | |
| CF - Crystalline | 90.5 | 90.2 | 88.5 | |
| fraction (Crystex), | | | | |
| wt % | | | | |
| C2 (Crystex), wt % | 4.5 | 4.7 | 12.8 | 10.7 |
| C3 (Crystex), wt % | 95.5 | 95.3 | 87.2 | |
| C2 in Soluble fraction | 24.7 | 24.1 | 33.5 | 32.1 |
| (SF) (Crystex), wt % | | | | |
| C2 in crystalline | 2.8 | 3.1 | 10.6 | 7.4 |
| fraction (CF) | | | | |
| (Crystex), wt % | | | | |
| IV of SF (Crystex), | 1.6 | 1.8 | 1.9 | 2.03 |
| dL/g | | | | |
| Melting point (main | 161.5 | 163.2 | | 163.5 |
| peak) (DSC), ° C. | | | | |
| Heat of fusion, (main | 96.8 | 97.8 | | 91.5 |
| peak) (DSC), ° C. | | | | |
| Crystallisation | 125.6 | 125.2 | | 124.7 |
| temperature (main | | | | |
| peak) (DSC), ° C. | | | | |
| Crystallisation | 93.6 | 93.8 | | 89.6 |
| Enthalpy (main peak) | | | | |
| (DSC), ° C. | | | | |
| CIELab | | | | |
| L* | 54.1 ± | 55.3 ± | 43 ⁽³⁾ | 39.3 |
| | 0.0 | 0.0 | | |
| a* | −5.4 ± | −1.5 ± | −0.86 | −1.81 |
| | 0.1 | 0.0 | | |
| b* | 1.7 ± | 2.5 ± | 0.86 | −1.73 |
| | 0.0 | 0.0 | | |
| Tensile Modulus (ISO | 1330 ± | 1438 ± | 1273 ⁽¹⁾ | 1322 ± |
| 527-2/1A), MPa | 4 | 6 | | 1 |
| Tensile Strength, | 29.3 ± | 29.5 ± | 25.7 ⁽⁴⁾ | 25.2 ± |
| MPa | 0.1 | 0.1 | | 0.0 |
| Tensile strain at | 133 ± | 44 ± | 18.9 ⁽⁴⁾ | 25.4 ± |
| break, % | 42 | 5 | | 3.9 |
| Flexural Modulus | 1268 ± | 1348 ± | 1209 ⁽²⁾ | 1264 ± |
| (ISO 178/type B), | 10 | 5 | | 7 |
| MPa | | | | |
| Charpy NIS +23° C. | 5.4 ± | 5.0 ± | 5.6 ⁽¹⁾ | 5.6 ± |
| (kJ/m²) | 0.2 | 0.4 | | 0.4 |
| Charpy NIS −20° C. | 1.9 ± | 1.9 ± | 2.5 | 2.7 ± |
| (kJ/m²) | 0.0 | 0.0 | | 0.5 |
| Eta(0.05 rad/s), Pa · s. | 2352 | 1880 | 1527 | 1241 |
| Eta(300 rad/s), Pa · s. | 221 | 206 | 208 | 186 |
| Shear Thinning | 10.6 | 9.1 | 7.3 | 6.7 |
| Factor (STF), | | | | |
| Eta(0.05)/Eta(300) | | | | |
| NLF @ 1000% | 2.6 ± | 2.7 ± | | |
| (LAOS) | 0.1 | 0.0 | | |

⁽¹⁾ Average of 20-30 samples
⁽²⁾ Average of 7 samples
⁽³⁾ Average of 10 samples
⁽⁴⁾ Average of 3 samples

From the above results it can be seen that the recycled polypropylene mixed color blend according to IE 1 and IE2 showed higher purity expressed as C2 content, particularly C2 content of the crystalline fraction (C2 (CF)), and lower emission properties (total carbon emission, VOC, FOG) than commercial products such as Purpolen® (CE1) or Van Werven (CE2). In addition, the inventive compositions showed excellent mechanical properties such as tensile modulus, tensile strain at break and impact strength.

The inventive compositions also exhibit high color consistency and brighter color shade (CIELab). The inventive compositions further exhibit good processability, expressed by higher Shear Thinning Factor, despite their lower MFR compared to the comparative examples.

1. A polypropylene mixed color blend obtained from post-consumer recyclates (PCR), said polypropylene mixed color blend having
(i) a crystalline fraction (CF) content determined according to CRYSTEX QC analysis, as determined herein, in the range from 85.0 to 95.0 wt.-%,
(ii) a soluble fraction (SF) content determined according to CRYSTEX QC analysis, as determined herein, in the range from 5.0 to 15.0 wt.-%,
(iii) a total ethylene content (C2), determined according to CRYSTEX QC analysis, as determined herein, in the range from 2.0 to 10.0 wt.-%,
(iv) said crystalline fraction (CF) has a propylene content (C3 (CF)) as determined by FT-IR spectroscopy calibrated by quantitative ¹³C-NMR spectroscopy, as determined herein, in the range from 93.0 to 99.0 wt.-%;
(v) said crystalline fraction (CF) has an ethylene content (C2 (CF)), as determined by FT-IR spectroscopy calibrated by quantitative ¹³C-NMR spectroscopy, as determined herein, in the range from [C2]-3.4 wt.-% to [C2]-0.2 wt.-%, wherein [C2] is the total ethylene content (C2) defined in (iii),
(vi) a CIELAB color space (L*a*b*) measured according to DIN EN ISO 11664-4, as described herein, of
L* from 30.0 to 73.0;
a* from −10 to 25;
b* from −5 to 20.

2. The polypropylene mixed color blend according to claim 1, having inorganic residues as measured by calcination analysis (TGA) according to DIN ISO 1172:1996 of 0.1 to less than 2.0 wt.-%, with respect to the total weight of the polypropylene mixed color blend.

3. The polypropylene mixed color blend according to claim 1, having a total carbon emission, measured by HS GC-FID according to VDA277 of from 1.0 to 30 μg carbon/g with respect to the total weight of the polypropylene mixed color blend.

4. The polypropylene mixed color blend according to claim 1, wherein said soluble fraction (SF) obtained by CRYSTEX QC analysis has an ethylene content (C2 (SF)), as determined by FT-IR spectroscopy calibrated by quantitative ¹³C-NMR spectroscopy, in the range from 20.0 to 30.0 wt.-%.

5. The polypropylene mixed color blend according to claim 1 having a Large Amplitude Oscillatory Shear-Non-Linear Factor (LAOS-NLF), determined at 190° C., an angular frequency of 0.628 rad/s and a strain of 1000%, as described herein
$$LAOS - NLF = \vert \frac{{G}_{1}^{′}}{{G}_{3}^{′}} \vert$$
whereby
G₁′ is the first order Fourier Coefficient
G₃′ is the third order Fourier Coefficient
in the range of 1.5 to 3.5.

6. The polypropylene mixed color blend according to claim 1 having a shear thinning factor (STF) value, defined as the ratio of the complex viscosities eta (0.05) and eta (300) at 230° C. within a frequency range of from 0.01 and 600 rad/s according to ISO 6721-1 and 6721-10, determined as described herein, in the range of from 7.5 to 15, and/or
having a total condensable organic content (FOG), measured by HS GC-FID according to VDA278 of from 20 to 450 μg/g with respect to the total weight of the polypropylene mixed color blend.

7. The polypropylene mixed color blend according to claim 1 obtained by visbreaking using peroxides.

8. The polypropylene mixed color blend according to claim 1 having a melt flow rate MFR_{2.16} at 230° C., determined as described herein of at least 5 g/10 min.

9. A method of recycling a polypropylene mixed color material, comprising the steps of:
a) providing a mixed plastic recycling stream (A);
b) sieving the mixed plastic recycling stream (A) to create a sieved mixed plastic recycling stream (B) having only articles with a longest dimension in the range from 30 to 400 mm;
c) sorting the sieved mixed plastic recycling stream (B) by means of one or more sorting systems including near infrared (NIR) and optical sensors wherein the sieved mixed plastic recycling stream (B) is at least sorted by color and polymer type and optionally article form, thereby generating a sorted mixed color polypropylene recycling stream (CM) that is subjected to steps d) and beyond;
d) shredding the sorted mixed color polypropylene recycling stream (CM) to form a flaked mixed color polypropylene recycling stream (D);
e) washing the flaked mixed color polypropylene recycling stream (D) with a first aqueous washing solution (W1) without the input of thermal energy, thereby generating a first suspended polypropylene recycling stream (E);
f) removing at least a part of the first aqueous washing solution (W1) from the first suspended polypropylene recycling stream (E) to obtain a first washed polypropylene recycling stream (F);
g) washing the first washed polypropylene recycling stream (F) with a second aqueous washing solution (W2) thereby generating a second suspended polypropylene recycling stream (G), wherein sufficient thermal energy is introduced to the second suspended polypropylene recycling stream (G) to provide a temperature in the range from 65 to 95° C. during the washing;
h) removing the second aqueous washing solution (W2) and any material not floating on the surface of the second aqueous washing solution (W2) from the second suspended polypropylene recycling stream (G) to obtain a second washed polypropylene recycling stream (H);
i) drying the second washed polypropylene recycling stream (H), thereby obtaining a dried polypropylene recycling stream (1), which contains the polypropylene mixed color blend according to any one of the preceding claims; and
j) separating the dried polypropylene recycling stream (I) obtained from step i) into a light fraction and a heavy fraction polypropylene recycling stream (J).

10. (canceled)

11. (canceled)

12. Blend comprising the polypropylene mixed color blend according to claim 1 and at least one virgin polypropylene and/or recycled polypropylene.

13. Article comprising the polypropylene mixed color blend according to claim 1, wherein said polypropylene mixed color blend amounts to at least 85 wt.-% of the components for making the article.

14. Article comprising the blend according to claim 12.

15. Article according to claim 13, being selected from the group consisting of caps, closures, bottles, containers, automotive articles, and wire and cable articles.

16. (canceled)

17. The blend of claim 1, wherein in step I), additives (Ad) are added in the melt state to form the extruded, pelletized, recycled polyethylene product (L).

18. The blend of claim 1, wherein additives (Ad) are added in the melt state to the purified polyethylene recycling stream (K) to form the extruded, pelletized, recycled polyethylene product (M3).

19. The blend of claim 1, wherein the extruded, pelletized, recycled polyethylene product (M3) is aerated.

20. A method for using the polyethylene mixed color blend of claim 1, comprising forming a household product, an automotive part, an appliance, a package, a wire, or a cable from the polyethylene mixed color blend.

21. A method for using the blend of claim 12, comprising forming a household product, an automotive part, an appliance, a package, a wire, or a cable from the blend.

22. The polypropylene mixed color blend obtained according to the method of claim 9.

23. The method of claim 9, further comprising at least one of the following steps:
k) further sorting the heavy fraction polypropylene recycling stream (J) or, in the case that step j) is absent, the dried polypropylene recycling stream (I) by means of one or more optical sorters sorting for one or more target polypropylene by removing any flakes containing material other than the one or more target polypropylene(s), yielding a purified polypropylene recycling stream (K);
l) melt extruding and pelletizing the purified polypropylene recycling stream (K) to form an extruded, pelletized, recycled polypropylene product (L);
m) optionally aerating the recycled polypropylene product (L) to remove volatile organic compounds, thereby generating an aerated recycled polypropylene product (M), being either an aerated extruded, pelletized, recycled polypropylene product (M1) or aerated recycled polypropylene flakes (M2), wherein the order of steps l) and m), if present, can be interchanged, such that the purified polypropylene recycling stream (K) is first aerated to form aerated recycled polypropylene flakes (M2) that are subsequently extruded to form an extruded, pelletized, recycled polypropylene product (M3), which is the polypropylene mixed color blend.
